(19) United States
(12) Patent Application Publication
(10) Pub. No.: US 2011/0198299 A1
(43) Pub. Date: Aug. 18, 2011

(54) PURIFICATION SHEET ASSEMBLY COMBINING FLOW OBSTACLES AND ELECTRIC FIELD FORMATION

(76) Inventors: Gideon Rosenberg, Tiveon (IL); Avner Rosenberg, Bet Shearim (IL)

(21) Appl. No.: 13/124,123

(22) PCT Filed: Oct. 1, 2009
(86) PCT No.: PCT/IL09/00950

§ 371 Date: Apr. 13, 2011

Related U.S. Application Data
(60) Provisional application No. 61/197,408, filed on Oct. 28, 2008.

(51) Int. Cl. C02F 1/48; B32B 3/30; H01B 7/00

(52) U.S. Cl. 210/748.01; 210/243; 428/172; 428/66.6

(57) ABSTRACT

An apparatus and method of a fluid containing microorganisms purification, comprising a stack of sheets each having patterns of ribs protruding from its surfaces and an embedded conductive foil connectable to a voltage source. In-between the stacked sheets the ribs engage to form fluid passageways in which electric field is generated by connecting said foils to a voltage source. The protrusions of some ribs from the sheet surface is smaller than others and they are shaped to locally amplify the electric field, thereby gate zones are formed along said passageways where the intensity of the electric field is effective for destruction of microorganisms in the fluid flow. The gate zones also deflect the fluid flow generating localized turbulence such that the time the fluid is residing along the passageway is extended and the microorganisms destruction action by the amplified electrical field is further enhanced.

### CROSS-REFERENCE TO RELATED APPLICATIONS

This application is being filed under 35 U.S.C 371 as a United States national patent application based on International Application Number PCT/IL2009/000950 filed on Oct. 1, 2009, which application claims priority to the United States Provisional Application for Patent that was filed on Oct. 28, 2008 and assigned Ser. No. 61/197,408, which application is hereby incorporated by reference.

### TECHNICAL FIELD

The present apparatus and method relate generally to the area of fluids purification and in particular to the area of fluid purification by application of an intense electric field to the fluid flow to destruct, eliminate or inactivate germs, viruses and other microorganisms. The electric field is applied by specially shaped obstacles which in addition to the electric field application form a turbulent fluid flow for better efficacy of eliminating the microorganisms.

### BACKGROUND

Fluid purification is a process of removing undesirable chemicals, particles, and microorganisms such as parasites, bacteria, algae, viruses, fungi, and others. Where the particles may be removed by filtration, the destruction or elimination of microorganisms is usually performed by chemical methods, for example by disinfectants like chlorine or by exposure to ultraviolet light.

In chemical fluid purification methods an antimicrobial agent is placed directly into a fluid to be purified. The agent may inhibit growth of microorganisms or eliminate and destroy the microorganisms. The residuals of the antimicrobial agent may impart on the purified fluid undesired taste, smell, or color limiting the further purified fluid use.

It is known that bacteria, viruses and other microorganisms may be inactivated or eliminated by strong electric field. The efficacy of destroying these microorganisms depends on the electric field intensity and the duration of the field application to the fluid. Some of the existing art teaches applications of electrostatic field as filters for arresting dust particles. The principles employed in these filter applications are based on use of the Coulomb force acting by the electric field on the charged particles to divert them from the streamline and then attract them. Typically, electrostatic field is applied to a flow of fluid flowing between two opposing electrodes, mostly parallel plates. Practically, such architecture forms a flat capacitor configuration that produces a uniform electric field in the fluid passageway. Voltage breakdown constitutes a major limiting factor on the intensity of the electric field generated in this configuration.

Since the intensity of the electric field is limited, such electric field application methods are not effective in eliminating microorganisms that may be present in a fluid. In order to effectively inactivate the microorganisms in a fluid, it would be desirable to have fluid purification apparatuses that include elements amplifying electric field and focusing its effect in specific gate zones where the fluid flows. The elements should be of such form and shape that they can be located in the fluid flow gateways and passageways and therefore act to inactivate or eliminate microorganisms present in the flow.

It would also be desirable to increase the duration of the electric field and fluid interaction. This will increase the interaction time between the amplified electric field and the fluid flow enhancing the electric field purification action. Fluid flow vortex, for example in a turbulent flow, would also be beneficial for fluid purification, since it will involve interaction of larger amount of fluid volumes with the electric field. Currently, there are no apparatuses or devices known to the authors of the present disclosure that support the described above functionality.

There is therefore a need for an apparatus operative to accept a fluid flow, apply to it an enhanced electric field sufficient to inactivate different microorganisms, form a flow ensuring intensive fluid mixing and extend the time of electric field fluid interaction. An apparatus that is simple in operation and maintenance and capable of providing a fluid flow free of different microorganisms.

### GLOSSARY

The term “fluid” as used in the present disclosure means gases such as air and other gases and liquids.

The term “microorganisms” as used in the present disclosure incorporates bacteria, viruses, and other microorganisms.

The term “sheet” or “ a sheet of material” as used in the present disclosure means a generally flat, multilayer article with a layer of an electrically conducting material embedded between at least two layers of electrically insulating material. One or both surfaces of the sheet may be patterned by a pattern of protruding elements, or ribs. The sheet may be of round (disc) shape having a hole in the center of the sheet, rectangular, or any other arbitrary shape.

In the context of the present disclosure the terms “radial ribs” used in describing disk shaped sheets are equivalent to the term “longitudinal ribs” for other than having circular symmetry sheet shapes.

In the context of the present disclosure the terms “tangential ribs” used in describing disk shaped sheets are equivalent to the term “transversal ribs” for other than having circular symmetry sheet shapes.

As used in the context of the present disclosure the term “purification” and “fluid purification” primarily means destruction, elimination or inactivation of microorganisms such as parasites, bacteria, algae, viruses, fungi, and others.

In the context of the present disclosure the terms “gateways”, “gate zones”, “gate points”, and “passageways” are used to describe different elements forming and directing fluid flow channel. “Passageway ” means a corridor like space formed to connect between the inlet port to the outlet of the fluid flow. “Gateway” means a narrower place that resides in the Passageway, e. g., orifice, which restricts the flow in the Passageway. “Gate zones” means the space in proximity to the Gateway and “Gate point” means the narrowest cross section point of a Gateway.

### BRIEF SUMMARY

A fluid purification apparatus includes an assembly of sheets that have on one or both surfaces of the sheet a pattern which may be a pattern of protrusions or ribs. When two sheets are assembled such that that the patterned surfaces face each other, some of the ribs are operative to form a fluid passageway between the sheets and some of the ribs form gateways that are operative to generate a turbulent fluid flow across the passageway. The sheet includes embedded electrodes extending through the area of the sheet.

Some of the ribs are a type of flow obstacles located along the passageway that operate to divert the flow in a number of directions and to create turbulent flow for extending the time of residence therefore increasing the duration of the electric field interaction with the fluid achieving even more uniform purification for any fluid volume element flowing in the gateway and passageway between the sheets.

Some of the ribs include special electric field shaping features or field shapers implemented as an integral part of the ribs. These field shaping features generate in designated locations of the fluid passageway termed gate points and gate zones a strong localized electric field by amplifying the electric field applied to the passageway through the electrode to a level sufficient to destroy different microorganisms. The gateways formed by the ribs of the opposing sheets extend the length of the fluid flow path and accordingly the time the fluid resides in the passageway. Extended fluid in the passageway residence combined with strong electric field at the gate zones supports better fluid purification action.

### BRIEF DESCRIPTION OF THE DRAWINGS

Exemplary embodiments of the present apparatus and method will be readily understood by the following detailed description in conjunction with the accompanying drawings. To facilitate this description, like reference numerals designate like structural elements. Embodiments of the apparatus and of the method are illustrated by way of example and not by way of limitation in the figures of the accompanying drawings.

FIG. 1 is a perspective view illustrating a first side of a first exemplary embodiment of a purification sheet.

FIG. 2 is a magnification of detail K of FIG. 1.

FIG. 3 is a perspective view illustrating a second side of the purification sheet of the first exemplary embodiment.

FIG. 4 is a magnification of detail L of FIG. 3.

FIG. 5 is a schematic illustration of cross section of an assembly of two exemplary purification sheets.

FIG. 6 is an enlarged cross section of a segment of the passageway illustrating the obstacles arranged along the passageway and the deflected fluid flow.

FIG. 7 is a schematic illustration providing an explanation of principle of amplified electric field formation and the physical rules governing the process.

FIG. 8 is a perspective view illustrating a first side of a second exemplary embodiment of the purification sheet implemented as a disc.

FIG. 9 is a magnification of detail M of FIG. 8.

FIG. 10 is a perspective view illustrating a second side of the second embodiment of the purification sheet implemented as a disc.

FIG. 11 is a magnification of detail N of FIG. 9.

FIG. 12 is a perspective view illustrating a first side of a third exemplary embodiment of the purification sheet implemented as a disc.

FIG. 13 is a magnification of detail O of FIG. 12.

FIG. 14 is a magnified top view illustrating a segment of the passageway in first surface of the third exemplary embodiment of FIG. 12 and the obstacles along the fluid flow.

### DETAILED DESCRIPTION OF EXEMPLARY EMBODIMENTS

In the following detailed description, reference is made to the accompanying drawings which form a part hereof, and in which is shown by way of illustration specific embodiments in which the apparatus and method may be practiced. In this regard, directional terminology, such as “top,” “bottom,” “front,” “back,” “upward,” “downward,” etc., is used with reference to the orientation of the Figure(s) being described. Because components of embodiments of the present invention can be positioned in a number of different orientations, the directional terminology is used for purposes of illustration and is in no way limiting.

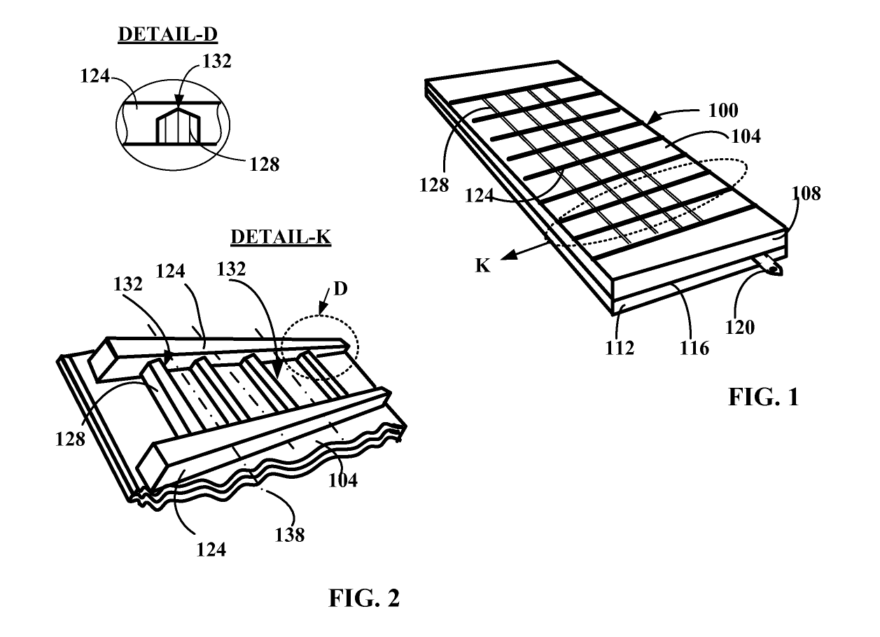

FIG. 1 is a perspective view illustrating a first side of a first exemplary embodiment of a purification sheet 100. Sheet 100 is a multilayer article having an embedded between two electrically insulating layers 108 and 112 a foil of electrically conductive material 116 such as a metal foil extending substantially the area of the insulating layers. The electrically conductive material 116 has a contact terminal 120, facilitating connection to a source of high voltage (FIG. 6). Sheet 100 may be produced by lamination or casting of the insulating material together with the conducting material 116. Conducting material 116 may be a metal foil or a metal grid. Conductive material 116 serves as an electrode. A pattern of longitudinal ribs 124 spanning from one side to the other of sheet 100 and transversal ribs 128 located between the longitudinal ribs 124 covers a first surface 104 of sheet 100. The ribs are made of the same insulating material as layers or sheets 108 and 112 and may be monolithic with the sheets.

FIG. 2 is a magnification of detail K of FIG. 1 illustrating in detail two adjacent longitudinal ribs 124 and located between them transversal ribs 128. The longitudinal ribs 124 extend or protrude from surface 104 on a dimension larger than the transversal ribs 128 protrude. A wedge type termination 132 terminates the protruding end of transversal ribs 128 facing outward from said sheet. Termination 132 may have a sharp or obtuse angle as shown in detail D and in some embodiments may have a different wedge shape. When high voltage is connected to electrode 120 the electric charges concentrate about the wedge type termination 132.

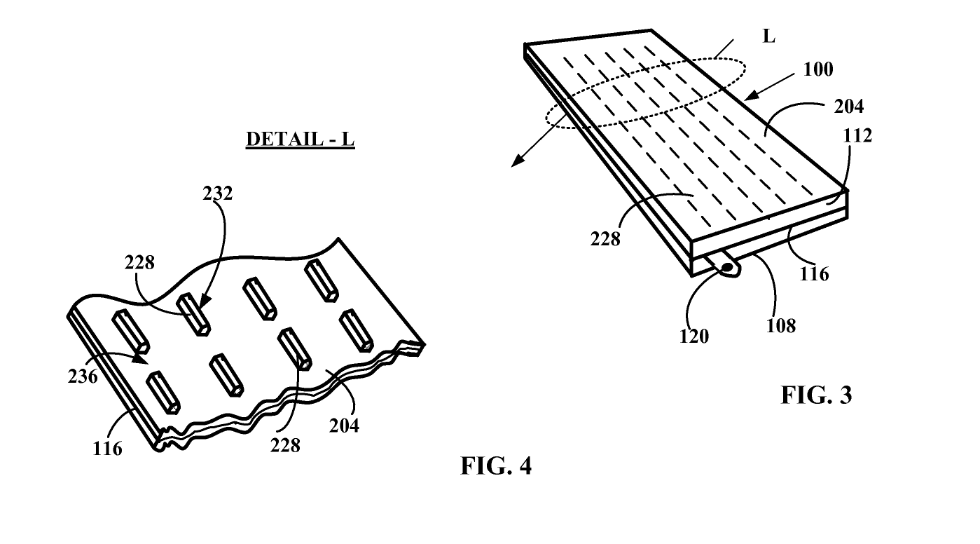

FIG. 3 is a perspective view illustrating a second side of a purification sheet of the first exemplary embodiment. A pattern of segmented transversal ribs 228 covers the surface 204 of sheet 112.

FIG. 4 is an expansion of detail L of FIG. 3 illustrating the structure of the segmented transversal ribs 228. Transversal ribs 228 are about the same size and in particular the protruding from surface 204 dimension as transversal ribs 128 located on the first surface 104 of sheet 100. A wedge type termination 232, similar to wedge type termination 132, terminates the protruding end of transversal ribs 228 facing outward from said sheet. Termination 232 may have a sharp or obtuse angle and in some embodiments may have a different wedge shape. A gap 236 divides between neighboring, located on the same line transversal ribs 228. Gap 236, although located on the second surface 204 is aligned with the located on the first surface 104 (FIG. 1) longitudinal rib 124 and the location of any one of transversal ribs 228 is aligned about the center line 138 (FIG. 2) between the two respective transversal ribs 128 located on the first surface 104 of sheet 100.

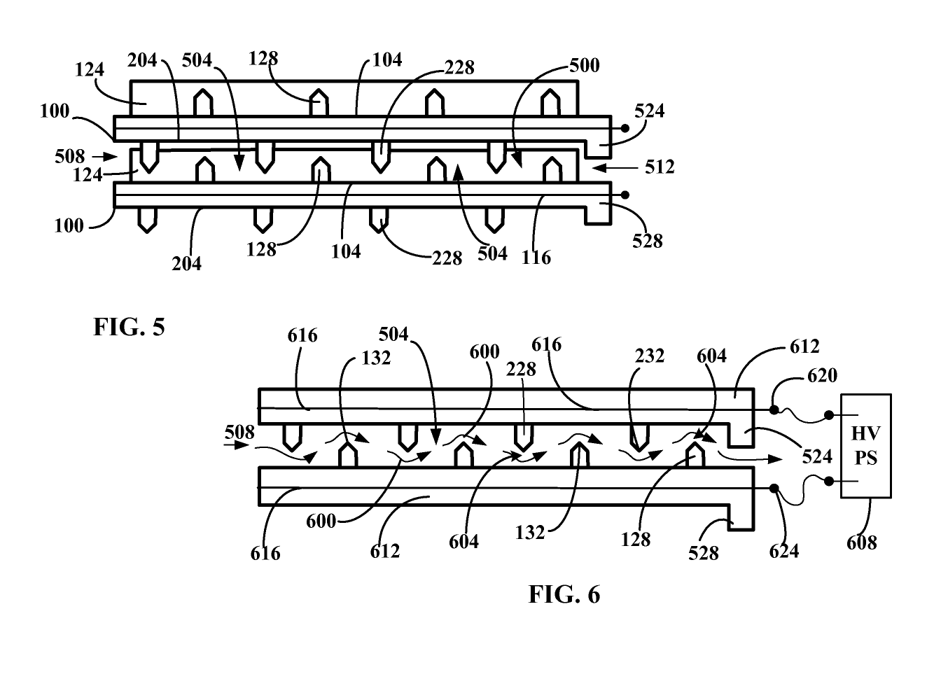

FIG. 5 is a schematic illustration of cross section of an exemplary embodiment of an assembly of two purification sheets. Sheets 100 are assembled into a stack such that the first patterned surface 104 of one of the sheets 100 faces and engages the second patterned surface 204 of the other sheet. In this example, both sheets or layers 100 are shown placed with its longitudinal rib 124 and its transversal ribs 128 in the upward direction. The upper sheet 100 is shown placed over the first or lower sheet 100 with its segmented transversal ribs 228 in the downward direction where each group of the segmented ribs 228 is placed between two adjacent longitudinal ribs 124 (FIG. 1). The edge step 524 is made to align the engagement of both sheets when stacked or assembled together. Such assembly of two sheets forms a stack and the space 500 between the sheets forms a passageway 504 spanning from one side 508 of the sheet/stack to the other side 512 of the stack. Sheets 100 may be clamped together by any known method for example, such as, pressing, use of screws and rivets, or joined together by adhesive or other known methods.

Longitudinal ribs 124 protrude out of surface 104 on a dimension exceeding that of transversal ribs 128 and 228 and another sheet 100 placed over the first sheet 100 rests with its surface 204 on longitudinal ribs 124. Accordingly, the passageway may be formed between two adjacent longitudinal ribs 124, surface 104 of the first sheet 100 and surface 204 of the second sheet 100. In the stack the transversal ribs 228 would typically be located about the center line 138 (FIG. 2) between the two respective transversal ribs 128 located on the first side 104 of sheet 100. Transversal ribs 128 and 228 located in the passageway 504 form a series of obstacles protruding up and down alternatively and operative to deflect the fluid flow as illustrated and explained below.

FIG. 6 is an enlarged cross section of a segment of the passageway illustrating the ribs or obstacles arranged along the passageway and the deflected fluid flow. This cross section is located between longitudinal ribs 124. Arrows 600 schematically illustrate the fluid flow, which is being deflected to flow through the gate points 604, underneath and over the obstacles 228 and 128 respectively and thereby a turbulent flow is generated. The length of the fluid flow path is increased such that the fluid resides longer times in the passageway. A high voltage power supply 608 provides voltage to embedded into each of the layers or sheets 612 insulating material metallic electrode layers 616 similar to layer 116 electrodes (FIG. 1) of sheets 100. Respective terminals 620 and 624 are in contact with the electrode layers 616 and further connected to a high voltage power supply 608.

When high voltage is supplied to the electrodes 616, it induces an electric charge at transversal ribs 128 and 228 located in the passageway 504 and in particular on the wedge shaped terminations 132 and 232 to cause electric charge concentration about the terminations and amplify the applied electric field forming an intense electric field about the wedge shaped terminations 132 and 232 of the transversal ribs. The magnitude of the intense electric field formed at the terminations 132 and 232 exceeds three to four times the electric field formed without shaped ribs.

In an additional exemplary embodiment the most inner, with respect to fluid entrance side 508 transversal ribs 524 and 528 may have an edge step termination. These edge step terminations 524 and 528 are made to align the engagement of both sheets when stacked or assembled together.

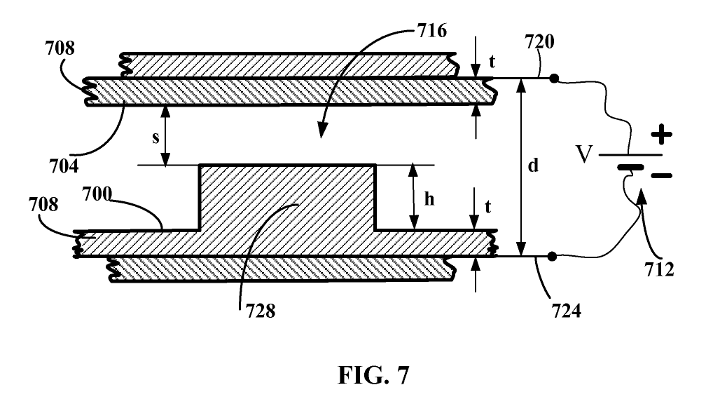

An explanation of the physical rules governing the process of amplified electric field formation in-between the sheets, and in particular at the gate points or zones, is provided below and illustrated in FIG. 7. FIG. 7 illustrates a single transversal electrode or a protruding obstacle 728 located in the passageway between the sheets 708. For the simplicity of explanation the sharp edges of the transversal ribs/obstacle are flattened.

Numerals 700 and 704 indicate opposing sheet 708 surfaces. Each of the sheets 708 has a thickness (t) and the obstacle 728 protrudes by a dimension (h) over the surface 700. Sheets 708 may be made of a plastic or dielectric material. An air gap of magnitude (s) forms a gate zone or point 716. Metallic foils or electrodes 720 and 724 are connected to high voltage source 712 generating a voltage V. The distance (d) between the foils is a sum of the thicknesses of the insulating or dielectric material of sheets 708, the width (s) of the gap, and the height of the obstacle (h). Accordingly, d=2t+h+s. In this configuration the electric field between the electrodes is the same as between flat capacitor plates. For example, in case of plates without dielectric layers, the field intensity (E) is defined as: E=V/d. For a combined media of different dielectric materials the displacement D in each layer is related to the electric field intensity by: D=εE and to the applied voltage V by: V=D(2t+h)/εₚ+Dₛ/ε₀, where εₚ and e₀ are dielectric constants for plastic and air respectively. εₚ is often expressed as eᵣ.ε₀ where εᵣ is a relative proportionality coefficient. The term (2t+h) can be replaced by (d-s), then the above equation may be converted to:

V=D[d+s(εᵣ−1)]/εᵣ. ε₀. The electric field Eg in the air gap (s) is related to the displacement D by E_{g}=D/ε₀, thus: E_{g}=V.εᵣ/[d+s(εᵣ−1)].

(The notations used are similar to those used in “Classical electrodynamics” By J. Jackson, second edition pages, 145-145 where the electrical displacement D is defined and the Coulomb law expression given in page 217 and V=∫{Edx} along the path from one electrode to the other, which is the basis for the voltage equation below, and also for V=E.d in a uniform length d. The relation D=εE is local. The boundary conditions of D at the interfaces are given by equation 4.40 on page 146 of Jackson, and since there are no free charges at the interface fluid-dielectric, the displacement D is the same in both materials i.e. continues in the interfaces.) A similar approach may be found for example, in:

http://www2.warwick.ac.uk/fac/sci/physics/teach/module_home/px263/handouts20 08/boundarye.pdf)

The relative dielectric coefficients eᵣ for most plastic materials are between 2.5 to 4.0. This coefficient may even be significantly increased by a proper supplemental filler, e.g. ceramic powder, into the plastic material. From the last equation one can find out that the dielectric material acts as multiplier of the electric field intensity at the gate zone, by a factor of about 3. The same equation also teaches that the field is inversely proportional to the gap (s).

Based on this model, it is possible to estimate the field intensity for a practical example of application of this apparatus and method.

The thickness of the plastic or dielectric layer is: t=0.5 mm

The distance between the conducting foils is: d=1.520 mm

The gap width is: s=0.020 mm

The applied voltage can be set to 6,000 Volts. This value is safe to avoid any voltage breakdown and arching.

The relative coefficients for plastic is taken in this example as: εᵣ=3.0

The resulting field intensity at the gate point will be: E_{g}=11,538 Volts/mm

In order to demonstrate the contribution of the electric field shapers amplifying the electric field, we can compare this result with a reference case where h=0. In this case s=d-2t, the equation for the field becomes: E=V.εᵣ/[d. εᵣ−2t(εᵣ−1)] and using the same as above parameters the reference field intensity without the field shapers is: E=7,031 Volts/mm Evidently the electric field amplification factor achieved by the protruding electric field shapers is 1.64.

Moreover, the above results can be compared to a reference value of the two plates without the dielectric or plastic layers. In this case the field is E=V/d=6,000/1.52=3,947 Volts/mm, or about ⅓ of the field intensity amplified by the field shapers. In consideration of this example one should count the fact that the dielectric strength of air can sustain up to about 3,000 Volts/mm, thus the dielectric or plastic coating of the plates is necessary to prevent voltage breakdown and arcing in the gate zones.

In view of the description of the above embodiments and the special features attained by the unique design of the purification sheets with patterned surfaces disclosed herein and, in particular the amplification of the electric field in the gate zones by the shaped terminations of the transversal ribs, the field intensity that can be generated by such sheet is 3 to 4 times more intense. From different publications (For example, Dan Bu et al, Journal of Electrostatics, Vol. 63, Issues 6-10, June 2005, 10^{th} International Conference on Electrostatics) it is known that microorganisms such as bacteria, viruses and other microorganisms were inactivated or destroyed by electric field with field intensities between 1,500 Volts/mm to 3,000 Volts/mm According to the calculation presented above, the purification apparatus constructed to with described above sheets may generate a field intensity of over 11,000 Volts/mm, far exceeding the threshold required for microorganisms destruction.

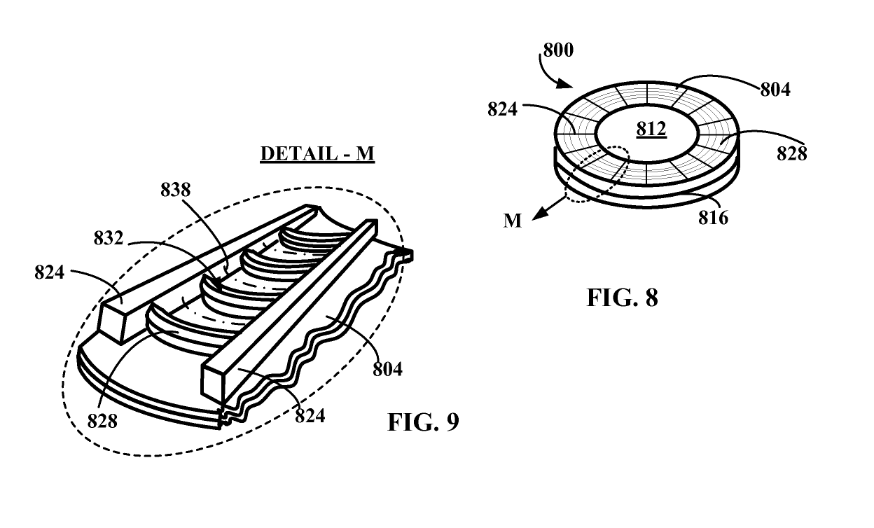

FIG. 8 is a perspective view illustrating a first side of the second exemplary embodiment of the purification sheet implemented as a disc. Disc 800 has on its first side 804 a pattern of radial ribs 824 and tangential ribs 828. Radial ribs 824 extend from the outside diameter of the disc to the most inner segment of the disc 800 defined by a hole 812. A conductive electrode 816 is incorporated into made from an insulating or dielectric material disc 800.

FIG. 9 is a magnification of detail M of FIG. 8 illustrating in detail two adjacent radial ribs 824 and located between them transversal ribs 828. The longitudinal ribs 824 protrude from surface 804 on a dimension larger than the transversal ribs 828 protrude. A wedge type termination 832 terminates the protruding end of transversal ribs 828 facing outward from said sheet. Termination 832 may have a sharp or obtuse angle and the wedge may have different configurations. Numeral 838 marks a centerline between two neighbor tangential ribs 828.

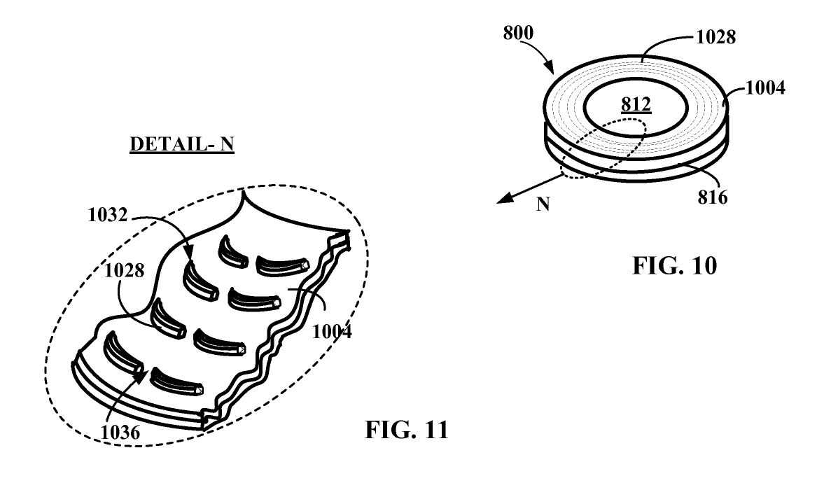

FIG. 10 is a perspective view illustrating a second side of the second exemplary embodiment of a purification sheet implemented as a disc. A pattern of segmented tangential ribs 1028 is distributed along concentric circles on the second surface 1004 of the sheet or disc 800.

FIG. 11 is a magnification of detail N of FIG. 10 illustrating the structure of the tangential ribs 1028. Tangential ribs 1028 are of the same size and in particular the protruding from surface 1004 dimension as tangential ribs 828 (FIG. 8). A gap 1036 divides between neighboring tangential ribs 1028 located on the same circle. Gap 1036, although located on the second surface 1004 of sheet 800 is aligned with located on the first surface 804 longitudinal rib 824 and the location of any one of tangential ribs 1028 is aligned about the center line 838 (FIG. 8) between the two respective transversal ribs 828 located on the first side 804 of disk 800. This structure of disc 800 allows to assemble multiple disc stacks such that the first patterned surface 804 of one of the discs 800 faces and engages the second patterned surface 1004 of the other disc. For this example, similar to the assembly of FIG. 5, one disc 800 may placed with its longitudinal rib 824 and its transversal ribs 828 in the upward direction. Another disc 800 may be placed over first disc 800 with its segmented transversal ribs 1028 in the downward direction where each group of the segmented ribs 1028 is placed between two adjacent radial ribs 824 (FIG. 9). Such assembly of two sheets forms a stack and the space between the disc shaped sheets forms plural gateways along a passageway spanning from external perimeter of the disc 800 to hole 812 at the inner side of the disc.

Radial ribs 824 protrude out of surface 804 on a height exceeding that of tangential ribs 828 and 1028 and another sheet 800 placed over the first or lower sheet 800 will lay on ribs 824. Accordingly, the passageway may be formed between two adjacent radial ribs 824, surface 804 of one of the discs 800 and surface 1004 of the other disc or sheet 800. In the stack the segmented transversal ribs 1028 would typically be located about the center line 838 (FIG. 9) between the two respective transversal ribs 828 located on the first side 804 of sheet 800. Transversal ribs 828 and 1028 located in a passageway such as 504 (FIG. 5) form a series of obstacles protruding up and down alternately, each obstacle leaves a clearance forming a gateway with the adjacent sheet face (804 or 1004). The obstacles are operative to deflect the fluid flow as it was illustrated and explained above.

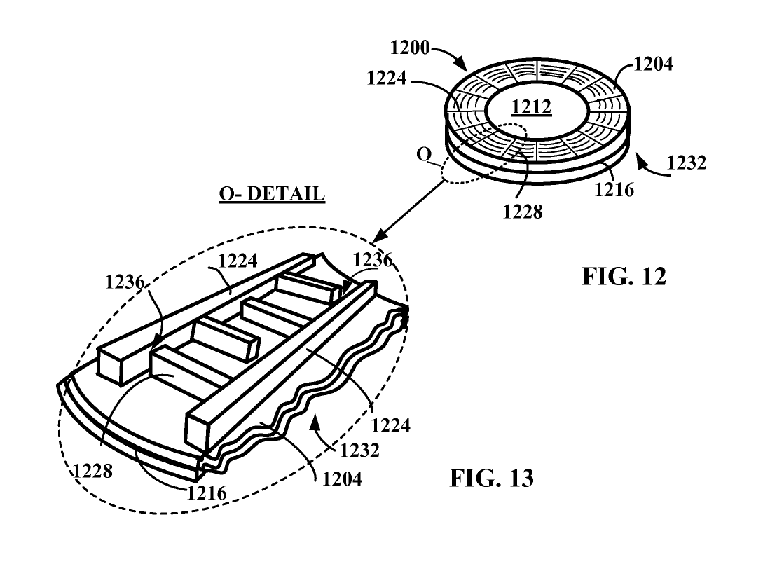

FIG. 12 is a perspective view illustrating a first side of the third exemplary embodiment of the purification disc. A pattern of radial ribs 1224 and tangential ribs 1228 is located on a first side 1204 of a purification disc 1200. Radial ribs 1224 span along most of the disc 1200 radius length from the external perimeter to hole 1212. The second side 1232 of the disc 1200 has a flat surface with no ribs on it and therefore is not shown in detail. A conductive electrode 1216 is incorporated into made of an insulating or dielectric material disc 1200.

FIG. 13 is a magnification of detail O of FIG. 12 illustrating that in this particular embodiment, the tangential ribs 1228 and the radial ribs 1224 are protruding from disc 1200 first side surface 1204 on the same dimension. Tangential ribs 1228 do not extend however, along the full width between two neighbor radial ribs 1224. The tangential ribs 1228 of this embodiment are extending alternately from one radial rib 1224 such that they almost touch the next radial rib 1224 leaving a narrow gap or clearance. This clearance forms gate zones and gateways 1236 located between the edge of the tangential rib 1228 and the alternating sides of radial ribs 1224. These gaps, together with the sides of radial ribs 1224 and surfaces 1204 and 1232 may form a labyrinth type passageway with each gate zone diverting the fluid flow alternately to the left and to the right sides of the gate points and accordingly extending the flow paths and increasing the time of fluid residence in the passageway.

The side edges of the tangential ribs 1228 or transversal obstacles forming the gate zones may be made either with flat ends to induce amplification of the electric field in the gate points, or with sharp ends to shape the field lines and thereby induce further amplification of the field in the gate points. This embodiment ensures a longer fluid path and increases the time the fluid resides in-between the inlet and outlet of the passageways. Since in this embodiment only one of the sheet or disc surfaces is patterned it is easier and less expensive to manufacture these types of discs.

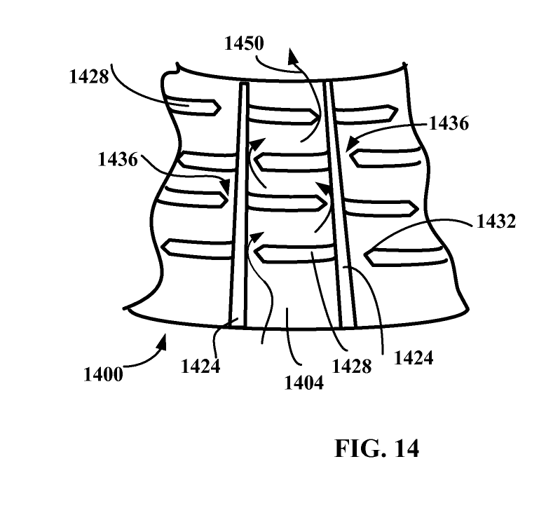

FIG. 14 is a magnified top view illustrating a first side of the third exemplary embodiment of the purification sheet implemented as a disc, another view of the disc illustrated in FIG. 13. It shows a segment of a disc 1400 on a first surface 1404 of which a labyrinth type passageway 1410 is formed by radial ribs 1424 and tangential ribs 1428. The tangential ribs 1428 and the radial ribs 1424 are protruding from disc 1400 first side surface 1404 on the same dimension. Tangential ribs 1428 do not extend however, along the full width between two neighbor radial ribs 1424. The tangential ribs 1428 of this embodiment are extending alternately from one radial rib 1424 such that they almost touch the next radial rib 1424 leaving a narrow gap or clearance. The edge 1432 of the tangential rib almost touching the radial rib 1424 may be terminated by a wedge type shape having a sharp or obtuse angle. Arrows 1450 show the extended fluid path within the passageway 1410 formed by the terminations 1432 of tangential ribs 1428. A conductive electrode (not shown) is incorporated into made of an insulating or dielectric material disc 1400.

This clearance forms gate zones and gate points 1436 located between the edge 1432 of the tangential rib 1428 and the alternating sides of radial ribs 1424. Arrows 1450 indicate fluid flow. The fluid flow is being deflected alternately to the left and to the right of the gate zones, along the curved labyrinth of the passageway, thereby the length of flow path is increased so that the fluid resides longer time in the passageway as well. The sharp edges 1432 of the tangential ribs 1428 amplify the electric field in the gate points of gate zones 1436 enhancing the fluid purification action.

Each of the described above sheet configurations may be used to form multiple sheet stacks employed in fluid purification and disinfection apparatuses. The process of fluid purification will be described now.

Initially, a stack of sheets such as sheets 100 or 800 (or 1200, 1400) of electrically insulated material with a pattern of longitudinal and transversal ribs and an electric contact embedded in each of the sheets is formed. The stack contains one or more fluid passageways formed by the space between the longitudinal ribs 124 (824, 1224, 1424) spanning along one surface of the disc. An assembly of the stack of sheets is mounted into an existing or new fluid purification system that includes a means of blowing or pumping a fluid, thereby introduces or couples the fluid flow to be purified to the passageways and gateways and a flow of the fluid through the passageway from one end of the passageway to the other is established.

The fluid flow carries the fluid along the passageway through gate zones formed by the transversal or tangential ribs distributed along the passageway. In some embodiments, the transversal or tangential ribs protrude from the sheet surface on a dimension smaller than the longitudinal ribs protrude and form a narrow gap or clearance between the transversal rib and the surface of the adjacent sheet. The transversal ribs operate as fluid flow obstacles. The gap or clearance between the transversal rib and the surface of the adjacent sheet is termed gate zone or gate point. The fluid flow is forced to pass through the gate zone. The gap is operative to deflect the fluid flow between the sheet surfaces and induce localized turbulence in the fluid flow.

A similar effect is produced when the transversal or tangential ribs are slightly shorter than the width of the passageway. The gate zone is formed at the clearance between the ends of the transversal ribs and the longitudinal ribs.

The electrical field generated by the high voltage supplied to the electrodes may be sufficient to destroy different microorganisms. The wedge shaped ends of the transversal ribs focus and amplify the electrical field in predetermined locations of the passageway, which are the gate zones. The field amplification is such that the electric field intensity in the gate zones may exceed the electric field formed by not shaped ribs three to four times. The electric field amplification or enhancement is achieved by the use of the dielectric material, novel surface pattern and/or by the sharp edges of the fluid flow obstacles. The amplified electric field intensity is sufficient to destroy or eliminate germs, viruses and other microorganisms and therefore the effectiveness of the apparatus and method to inactivate or eliminate germs, viruses and other microorganisms is substantially enhanced.

The described stacks of sheets may be used in manufacture of fluid purification and disinfection apparatuses. They are operative to purify a large range of fluid flows flowing with different speeds. The purification action includes different microorganisms inactivation and destruction.

While the invention has been described with respect to several preferred embodiments, it will be appreciated that these are set forth merely for purposes of example, and that many other variations, modifications and applications of the invention may be made.

What is claimed is:

1. A purification sheet, said sheet comprising:
a multilayer articles having a first and second layers of dielectric material and a foil of metallic material embedded between said dielectric material layers, wherein said foil is substantially planar and extends for substantially a complete area of the sheet, said article including:
a pattern of longitudinal ribs spanning from one edge to other edge of the sheet and transversal ribs extending between the longitudinal ribs, said ribs are made of dielectric material and are covering outer surface of said first layer, whereas said transversal ribs protrude over said outer surface on a dimension smaller than the longitudinal ribs protrude and wherein said transversal ribs are terminated by a sharp wedge type termination on its end facing outward from the sheet;
a pattern of segmented transversal ribs formed on the outer surface of said second layer, said segmented ribs are located about centerlines between the transversal ribs located on said first layer and gaps aligned about the location of the longitudinal ribs located on said first layer divide between neighboring segmented transversal ribs, the segmented ribs are made of dielectric material and are covering the outer surface of said second layer, whereas said segmented ribs protrude over a second outer surface on a dimension smaller than the longitudinal ribs protrude over said first outer surface and wherein said transversal ribs are terminated by a sharp wedge type termination on its end facing outward from the sheet.

2. The sheet according to claim 1, wherein said dielectric material has a dielectric coefficient larger than 3.0 and wherein said transversal ribs sharp wedge type terminations cause electric charge concentration about the termination and amplify applied electric field forming an intense electric field about the sharp wedge type termination of the transversal ribs.

3. The sheet according to claim 1, wherein the sheet is disc shaped and has a hole in the center, wherein the longitudinal ribs are radial ribs and the transversal ribs are tangential and wherein said dielectric material has a dielectric coefficient larger than 3.0.

4. The sheet according to claim 1, wherein the metallic foil is made with a conductive terminal electrode operative to connect the foil to a voltage source.

5. A purification sheet, said sheet comprising:
a multilayer articles having a first and second layers of dielectric material and a foil of metallic material embedded between said dielectric material layers, wherein said foil is substantially planar and extends for substantially a complete area of the sheet, said article including:
a pattern of longitudinal ribs spanning from one edge to other edge of the sheet and transversal ribs extending between the longitudinal ribs, said ribs are made of dielectric material and are covering outer surface of said first layer, said transversal ribs protrude over said outer surface on a dimension equal to the longitudinal ribs protrude and are configured to leave small gaps at each of alternate ends of the transversal ribs proximate to the longitudinal ribs, wherein said transversal ribs are terminated by a sharp wedge type termination on its end forming the gaps with the longitudinal ribs; and
a flat outer surface on said second layer of the sheet.

6. The sheet according to claim 5, wherein said dielectric material is having a dielectric coefficient larger than 3.0 and wherein said sharp wedge type terminations of the transversal ribs cause electric charge concentration about the termination and amplify applied electric field forming an intense electric field about the sharp wedge type termination of the transversal ribs.

7. The sheet according to claim 5, wherein the sheet is disc shaped and has a hole in the center, wherein the longitudinal ribs are radial ribs and the transversal ribs are tangential ribs and wherein said dielectric material has a dielectric coefficient larger than 3.0.

8. The sheet according to claim 5, wherein the metallic foil is made with a conductive terminal electrode operative to connect the foil to a voltage source.

9. An apparatus for fluid purification, said apparatus comprising:
a stack of at least two purification sheets each of said sheets comprising:
at least one multilayer article having a first and second layer of dielectric material and a foil of metallic material embedded between said dielectric material layers and a conductive terminal electrode operative to connect the foil to a voltage source, said article including:
a pattern of longitudinal ribs spanning from one edge to other edge of the sheet and transversal ribs extending between the longitudinal ribs, said ribs are made of dielectric material and are covering outer surface of said first layer, whereas said transversal ribs protrude over said outer surface on a dimension smaller than the longitudinal ribs protrude and wherein said transversal ribs are terminated by a sharp wedge type termination on its end facing outward from the sheet;
a pattern of segmented transversal ribs formed on outer surface of said second layer, said segmented ribs are located about central lines between the transversal ribs located on said first layer and gaps aligned about the location of the longitudinal ribs located on said first layer divide between neighboring segmented transversal ribs, the segmented ribs are made of dielectric material and are covering the outer surface of said second layer, whereas said segmented ribs protrude over a second outer surface on a dimension smaller than the longitudinal ribs protrude over said first outer surface and wherein said transversal ribs are terminated by a sharp wedge type termination on its end facing outward from the sheet;
a passageway formed by the stack of the two sheets clamped such that the longitudinal ribs located on the outer surface of said first layer of one of the sheets settle in the gaps between the segmented transversal ribs located on the outer surface of said second layer of a second sheet; and wherein the segmented transversal ribs located on the outer surface of said second layer of the second sheet settle between the longitudinal ribs and about the center lines of the neighbor transversal ribs located on the outer surface of said first layer of the first sheet; and
a plurality of fluid flow obstacles formed by the transversal ribs located along the passageway; and
a source of high voltage operative to provide high voltage to the metallic foils and form an electric field in the passageway wherein the sharp wedge type termination of said transversal ribs are operative to cause electric charge concentration about the termination and amplify the electric field applied thereby forming an intense electric field in the passageway.

10. The apparatus for fluid purification according to claim 9, wherein said dielectric material has a dielectric coefficient larger than 3.0.

11. The apparatus for fluid purification according to claim 9, wherein said purification sheet is disc shaped and has a hole in the center, wherein the longitudinal ribs are radial ribs and the transversal ribs are tangential ribs and wherein said dielectric material has a dielectric coefficient larger than 3.0.

12. An apparatus for fluid purification, said apparatus comprising:
a stack of at least two purification sheets each of said sheets comprising a multilayer articles having a first and second layers of dielectric material and a foil of metallic material embedded between said dielectric material layers and a conductive terminal electrode operative to connect the foil to a voltage source, said article including:
a pattern of longitudinal ribs spanning from one edge to other edge of the sheet and transversal ribs extending between the longitudinal ribs, said ribs are made of dielectric material and are covering the outer surface of said first layer, said transversal ribs protrude over said outer surface on a dimension equal to the longitudinal ribs protrude and are configured to leave small gaps at each of alternate ends of the transversal ribs proximate to the longitudinal ribs, wherein said transversal ribs are terminated by a sharp wedge type termination on its end forming the gaps with the longitudinal ribs ; and
a flat outer surface on said second layer of the sheet;
a passageway formed by the stack of the two sheets clamped such that the transversal ribs create a plurality of fluid flow obstacles located along the passageway forming a labyrinth shape; and
a source of high voltage operative to provide high voltage to the metallic foils and form an electric field in the passageway wherein the sharp wedge type termination of said transversal ribs are operative to cause electric charge concentration about the termination and amplify the electric field applied thereby forming an intense electric field in the passageway.

13. The apparatus for fluid purification according to claim 12, wherein said dielectric material has a dielectric coefficient larger than 3.0.

14. The apparatus for fluid purification according to claim 12, wherein said purification sheet is disc shaped and has a hole in the center, wherein the longitudinal ribs are radial ribs and the transversal ribs are tangential and wherein said dielectric material has a dielectric coefficient larger than 3.0.

15. A method of fluid flow containing different microorganisms purification, said method comprising:
providing a stack of at least two purification sheets each of said sheets comprising a multilayer articles having a first and second layers of dielectric material and a foil of metallic material embedded between said dielectric material layers and a conductive terminal electrode operative to connect the foil to a voltage source, wherein each sheet having a pattern of ribs on each of the sheet surfaces and wherein some of the ribs are terminated by sharp wedge type terminations;
clamping the stack such that the pattern of ribs located on a first surface of one of the sheets settles between the pattern of ribs located on second surface of the second sheet; and
forming at least one fluid passageway with one or more transversal ribs located inside the passageway wherein its sharp wedge type termination is directed into the passageway;
introducing into the passageway a flow of fluid to be purified and flowing the fluid through the passageway;
applying an electric field to the metallic foil, amplifying the electric field about sharp edges of the ribs and purifying the fluid in the passageway; and
forming in a fluid flow localized turbulent flow zones and deflect the fluid flow in different directions inside the passage way to extend the length of time the fluid resides in the passageway.
